(19) United States
(12) Patent Application Publication
(10) Pub. No.: US 2016/0018431 A1
(43) Pub. Date: Jan. 21, 2016

(54) BERRY IMPACT RECORDING DEVICE

(71) Applicant: University of Georgia Research Foundation, Inc., Athens, GA (US)

(72) Inventors: Rui Xu, Athens, GA (US); Changying Li, Watkinsville, GA (US)

(21) Appl. No.: 14/802,253

(22) Filed: Jul. 17, 2015

Related U.S. Application Data
(60) Provisional application No. 62/026,255, filed on Jul. 18, 2014.

(51) Int. Cl. G01P 1/12; A01D 46/24; G01P 15/04; G01P 15/18; G01P 1/02

(52) U.S. Cl. CPC G01P 1/127; G01P 15/18; G01P 1/023; G01P 15/04; A01D 46/24

(57) ABSTRACT

Disclosed are various embodiments for a berry impact recording device. The berry impact recording device comprises a shell. Within the shell are at least a sensor and an integrated circuit. The sensor may be configured to detect an acceleration of the berry impact recording device. The integrated circuit may be configured to record the acceleration of the berry impact recording device and a timestamp corresponding to the acceleration.

### CROSS REFERENCE TO RELATED APPLICATIONS

This application claims priority to, and the benefit of, U.S. Provisional Application No. 62/026,255, filed on Jul. 18, 2014, and incorporated by reference herein in its entirety.

### STATEMENT REGARDING FEDERALLY SPONSORED RESEARCH OR DEVELOPMENT

This invention was made with government support under grant no. 2008-51180-19579 awarded by the U.S. Department of Agriculture. The government has certain rights in this invention.

### BACKGROUND

Berries may be harvested from fields by hand or using mechanical harvesting and processing machines. However, the use of mechanical harvesting and processing machines results in a higher percentage of bruised and/or damaged berries as compared to harvesting and processing by hand. Mechanical harvesting and processing causes a large number of mechanical impacts to be inflicted upon berries in comparison to harvesting and processing by hand.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of berry impact recording device.

FIG. 2 is a schematic block diagram of the circuit board of the berry impact recording device depicted in FIG. 1.

FIG. 3 is a flowchart illustrating one example of functionality implemented within the circuit board of the berry impact recording device depicted in FIG. 1 according to various embodiments of the present disclosure.

FIG. 4 is a flowchart illustrating one example of functionality implemented within the circuit board of the berry impact recording device depicted in FIG. 1 according to various embodiments of the present disclosure.

FIG. 5 is a flowchart illustrating one example of functionality implemented within the circuit board of the berry impact recording device depicted in FIG. 1 according to various embodiments of the present disclosure.

### DETAILED DESCRIPTION

Disclosed are various embodiments for a berry impact recording device. The berry impact recording device may measure the mechanical impact imparted on various berries by mechanical harvesting and processing techniques. The berry impact recording device may, in various embodiments, use an accelerometer or a pressure sensor. A series of mechanical impacts may, in some embodiments, be recorded over a period of time. In the following discussion, a general description of the system and its components is provided, followed by a discussion of the operation of the same.

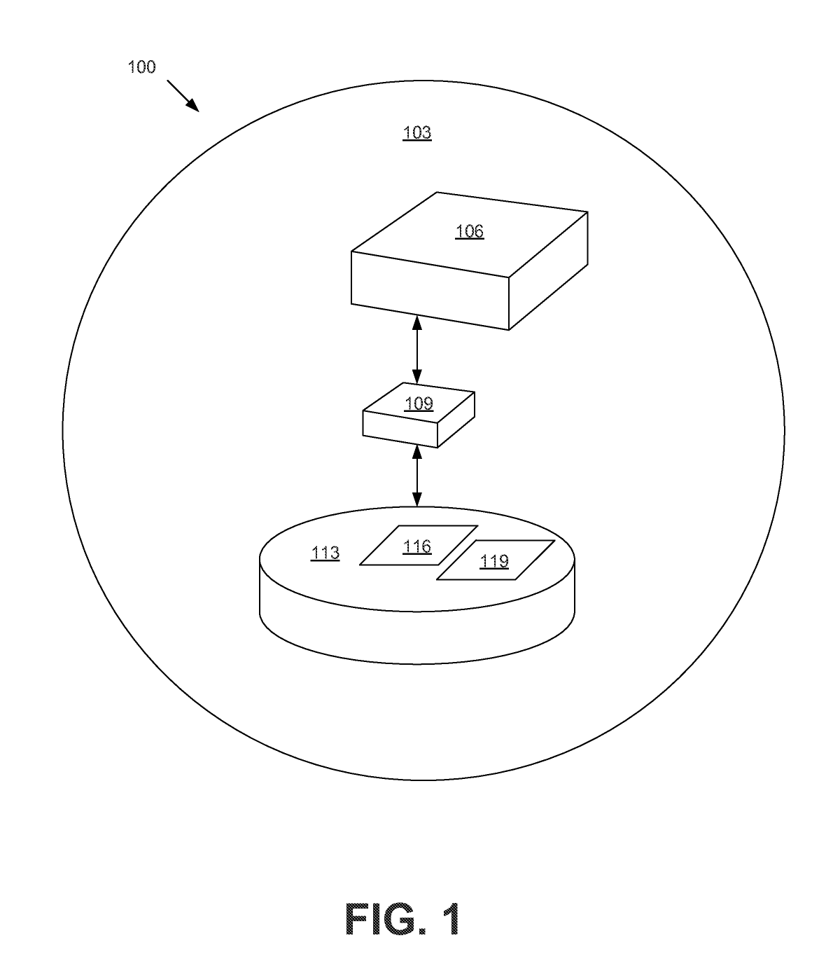

Beginning with FIG. 1, a berry impact recording device 100 is depicted according to various embodiments of the present disclosure. The berry impact recording device 100 includes an outer shell 103, a battery 106, a sensor 109, and a circuit board 113. Generally, the berry impact recording device 100 is constructed to match the size, shape, and weight of the berry that is being processed. For example, if the berry impact recording device 100 is to be used to record impacts to blueberries during the processing of blueberries, the berry impact recording device 100 would be spherical in shape with a diameter no larger than 0.25 inches, which is approximately the diameter of a large blueberry. However, the berry impact recording device may be shaped and sized to match other berries or fruits, such as strawberries, cherries, blackberries, raspberries, and/or other fruits.

The outer shell 103 may be formed from any suitable material of sufficient weight, strength, and durability to survive mechanical agricultural processes, house the remaining components of the berry impact recording device 100, and match the weight of the particular berry that the berry impact recording device 100 is designed to imitate. Example materials include rubber and rubberized plastic or resin.

The battery 106 may include any battery capable of providing sufficient power for the berry impact recording device 100 to operate through the mechanical harvesting and/or mechanical processing of berries. The battery 106 supplies power to the sensor 109 and the circuit board 113.

The sensor 109 may include any one or more of a number of sensors capable of measuring motion, acceleration, and/or impact data. The sensor 109 may include, for example, a microelectricomechanical systems (MEMS) gyroscope, a MEMS pressure sensor, and/or other MEMS sensors. In those embodiments that use a MEMS gyroscope to measure changes in acceleration of the berry impact recording device 100, the sensor 109 may be configured to measure changes in acceleration along the X-axis, Y-axis, and/or Z-axis. For example, in some embodiments, the berry impact recording device 100 may include a tri-axis accelerometer as the sensor 109 in order to minimize the size of the berry impact recording device 100 as compared to embodiments that use multiple sensors 109 to measure changes in acceleration along the X-axis, Y-axis, and Z-axis. Embodiments that use a single sensor 109 instead of multiple sensors 109 may allow the berry impact recording device 100 to be similar in size and weight to actual berries.

The circuit board 113 includes the control logic and electrical circuitry necessary for the operation of the berry impact recording device 100. The circuit board 113 may, for example, determine whether to record or store measurements provided by the sensor 109. The circuit board 113 may also, for example, determine when the sensor 109 is to make measurements. The circuit board 113 may also, in some embodiments, be configured to send data to another computing device or allow another computing device to retrieve data from the circuit board, such as sensor readings and corresponding timestamps. For example, the circuit board 113 may include a serial port interface 116 that complies with the RS-232 standard for communication with external devices or a universal serial bus (USB) interface 119 that complies with one or more versions of the USB standard for communication with external devices. Due to the small size of the berry impact recording device, some embodiments may use a USB interface that complies with the USB Mini-A, USB Mini-B, USB Mini-AB, USB Micro-A, USB Micro-B, USB Micro-AB, or USB Type C standard in order to minimize the size of the berry impact recording device. The serial port interface 116 or the USB interface 119 may be externally accessible through a port or other opening in the outer shell 103.

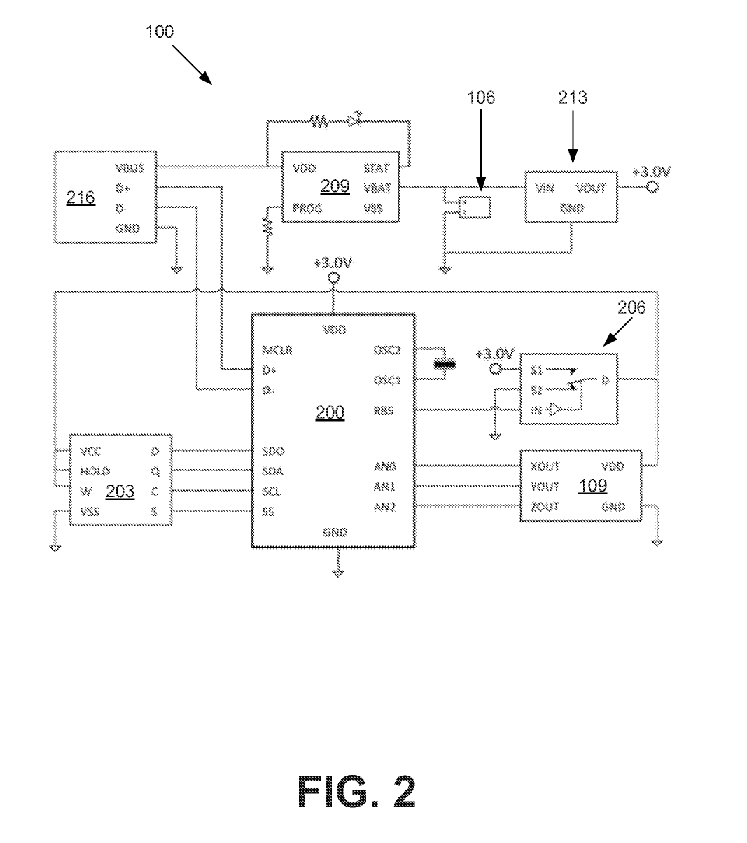

Proceeding to FIG. 2, depicted is circuit diagram detailing the electrical connections of the components of a berry impact recording device 100. Shown are a microcontroller 200, a memory 203, an analog switch 206, a charge controller 209, a voltage regulator 213, a battery 106, and a sensor 109. The microcontroller 200, memory 203, analog switch 206, charge controller 209 and/or regulator 213 may be components of the circuit board 113 (FIG. 1) in some embodiments of the present disclosure.

The microcontroller 200 may be selected for reasonably fast operation speed, low power consumption, and a small package size sufficient to fit into a volume equivalent to that of a common berry and leave room remaining for other components of the berry impact recording device 100. The microcontroller may include a number of components, such as a central processing unit (CPU) to execute software instructions, a serial port controller that provides communications via a serial port, and/or a universal serial bus (USB) controller that provides via a USB port. The serial port controller or the USB controller may be electrically and/or communicatively coupled to a serial port interface (SPI) or a USB interface on the circuit board 113 in order for the microcontroller 200 to communicate with external devices or peripherals. The microcontroller 200 may also be configured to execute any logical functions necessary for the functionality of the berry impact recording device 100 as may be further described herein.

The memory 203 may include any suitable memory. Common criteria may include fast write speeds, low power consumption, high density, and a long life cycle. For example, NAND and/or NOR flash memory, as well Ferroelectric Random-Access Memory (F-RAM) may be used. Other types of non-volatile memory, such as Electrically Erasable Programmable Read-Only Memory (EEPROM) may be unsuitable for use in a berry impact recording device 100 due to slow write speeds and/or short life cycles as a result of an unacceptably low number of mean read-write cycles between failures.

The analog switch 206 allows for turning the berry impact recording device 100 on or off. When set to the off position, the analog switch 206 is set in a position that breaks the circuit and, therefore, the flow of electric current through the berry impact recording device 100. When set to the on position, the analog switch is set in a position that completes the circuit and, therefore, permitting the unimpeded flow of electric current through the system.

The charge controller 209 accepts an external electrical current and uses it to charge the battery 106. For example, the charge controller 209 may be coupled to or include a universal serial bus (USB) port or a direct current power input. The charge controller 209 then uses the received current to recharge the battery 106. The charge controller 209 may also be configured to prevent the battery 106 from overcharging or from discharging too rapidly (or not rapidly enough).

The voltage regulator 213 regulates the voltage of the electrical current provided by the battery 106. For example, the voltage regulator 213 may increase or decrease the voltage of the electric current supplied by the battery 106 to match the voltage necessary for the operation of other components, such as the microcontroller 200, memory 203, analog switch 206, charge controller 209, and/or sensor 109

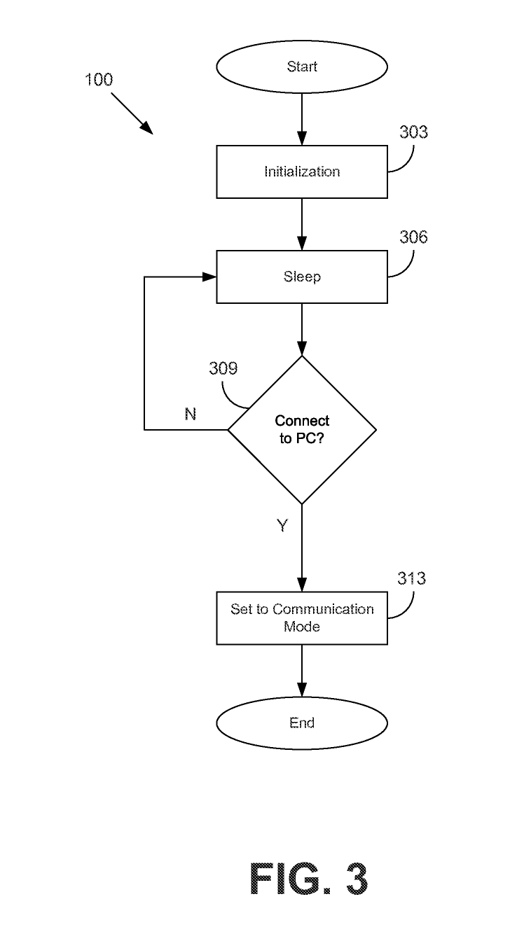

Referring next to FIG. 3, shown is a flowchart that provides one example of the operation of a portion of the berry impact recording device 100 while in sleep mode according to various embodiments. It is understood that the flowchart of FIG. 3 provides merely an example of the many different types of functional arrangements that may be employed to implement the operation of the portion of the berry impact recording device 100 as described herein. As an alternative, the flowchart of FIG. 3 may be viewed as depicting an example of elements of a method implemented in the berry impact recording device 100 according to one or more embodiments.

Beginning with box 303, the berry impact recording device 100 is turned on. In response, the microcontroller 200 performs various initialization functions. These initialization functions may include a power-on self-test (POST) for each of the components of berry impact recording device 100. The microcontroller 200 (FIG. 2) may also set the values for the various hardware and software components to default values or to the last known value as saved in the memory 203 (FIG. 2)

Moving on to box 306, the berry impact recording device 100 enters a sleep state. To enter the sleep state, the microcontroller 200 may signal the sensor 109 (FIG. 1) and/or the memory 203 to power off. The microcontroller 200 may then enter a suspended operation mode, in which the microcontroller 200 may only responds to external interrupts. As a result, the power drain on the battery 106 (FIG. 1) may be minimized.

Proceeding to box 309, the microcontroller 200 determines whether an external interrupt received corresponds to an indication that the berry impact recording device 100 has been connected to a computing device, such as a desktop computer, laptop computer, smartphone, tablet computer, or other computing device that implements a universal serial bus (USB). For example, the USB controller of the microcontroller 200 may detect that a computing device has been attached to the USB interface of the circuit board 113 as a result of a signal received from the USB interface by the microcontroller 200. If a computing device has been connected, then execution proceeds to box 313. If the computing device has not been connected, then the berry impact recording device 100 continues to sleep as described at box 306.

Referring next to box 313, the microcontroller 200 causes the berry impact recording device 100 to enter communication mode. To enter communication mode, the microcontroller 200 may cause the memory 203 to power on, and the microcontroller 200 itself may resume from its previously suspended operation so that the microcontroller 200 can both respond to external interrupts and execute various program instructions. Execution of the previously described process subsequently ends.

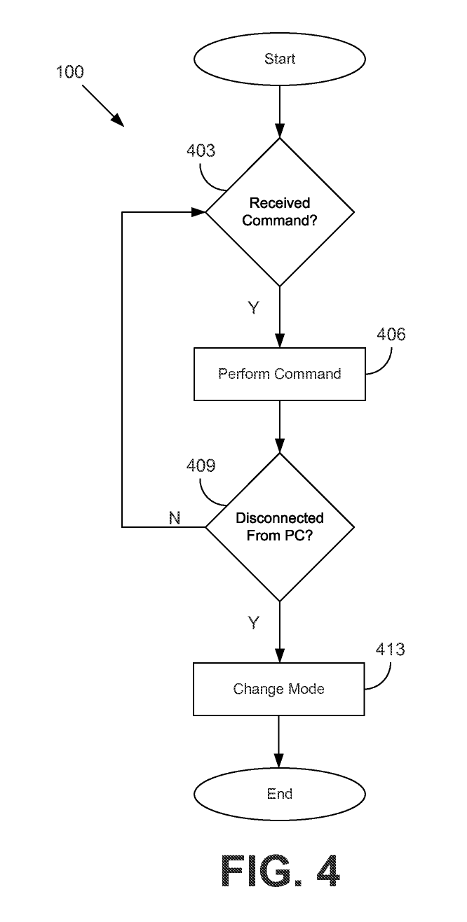

Referring next to FIG. 4, shown is a flowchart that provides one example of the operation of a portion of the berry impact recording device 100 while in communication mode according to various embodiments. It is understood that the flowchart of FIG. 4 provides merely an example of the many different types of functional arrangements that may be employed to implement the operation of the portion of the berry impact recording device 100 as described herein. As an alternative, the flowchart of FIG. 4 may be viewed as depicting an example of elements of a method implemented in the berry impact recording device 100 according to one or more embodiments.

Beginning with box 403, the berry impact recording device 100 determines whether a command has been received. For example, the microcontroller 200 (FIG. 2) may data received via the universal serial bus (USB) interface or serial port interface (SPI) on the circuit board 113 (FIG. 1) to determine if a command has been issued to the berry impact recording device. For example, the microcontroller 200 may determine the presence of a specific series of bit values that indicates a “start to sample” command, a “configure sensor” command, or an “upload sensor data to computer” command. If a command has been received, then execution proceeds to box 406. If no command has been received, then the berry impact recording device 100 waits to receive a command.

Moving on to box 406, the microcontroller 200 causes the berry impact recording device 100 to perform the command received. For example, if an “enter sample mode” or similar command is received, the microcontroller 200 will store the values for the frequency at which the sensor 109 (FIG. 1) will sample data and the threshold above which the sensor 109 will record a sample of data. These values may be default value or may be specified through an application executing on the connected computing device. The microcontroller 200 would then cause the berry impact recording device 100 to enter sampling mode after the berry impact recording device 100 has been disconnected from the attached computing device.

Proceeding next to box 409, the berry impact recording device 100 determines whether it has been disconnected from the attached computing device. For example, the USB controller of the microcontroller 200 may detect that the attached computing device has been detached from the USB interface of the circuit board 113 as a result of a signal received from the USB interface by the microcontroller 200. If the berry impact recording device 100 has been disconnected from the attached computing device, then execution proceeds to box 413. If the computing device remains attached to the berry impact recording device 100, then execution proceeds back to box 403 for processing of additional commands.

Referring next to box 413, the berry impact recording device 100 switches to sampling mode or sleep mode, depending on the previous commands received. For example, if an “enter sample mode” or “start sampling” command were received, then the berry impact recording device 100 would enter sampling mode. However, if only commands related to retrieving data from berry impact recording device 100 were received, then the berry impact recording device 100 may return to sleep mode. After changing to sleep mode or sampling mode, execution of the previously described process subsequently ends.

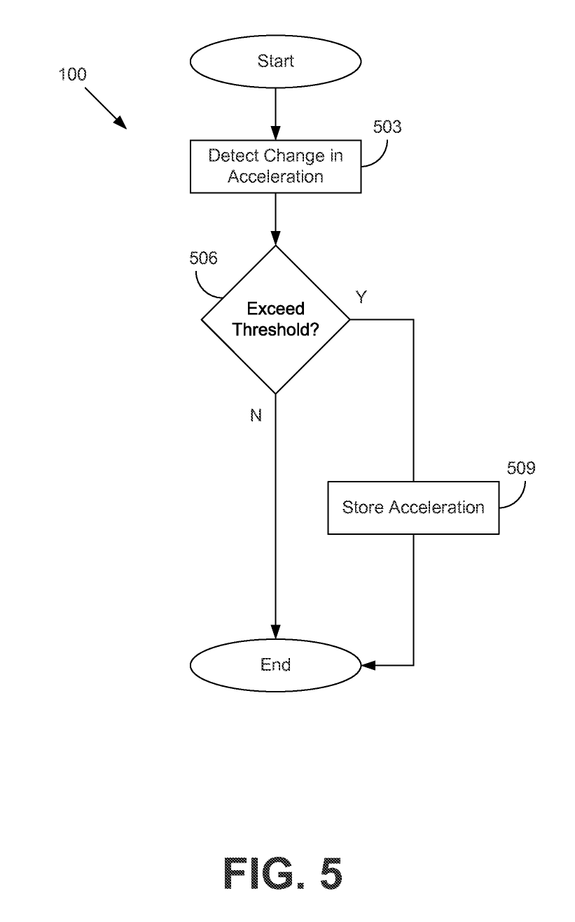

Referring next to FIG. 5, shown is a flowchart that provides one example of the operation of a portion of the berry impact recording device 100 while in sampling mode according to various embodiments. It is understood that the flowchart of FIG. 5 provides merely an example of the many different types of functional arrangements that may be employed to implement the operation of the portion of the berry impact recording device 100 as described herein. As an alternative, the flowchart of FIG. 5 may be viewed as depicting an example of elements of a method implemented in the berry impact recording device 100 according to one or more embodiments.

Beginning with box 503, the sensor 109 (FIG. 1) registers a change in the acceleration of the berry impact recording device 100. The change in acceleration may be detected along one or more axes of movement, such as the X-axis, Y-axis, and/or Z-axis.

Proceeding to box 506, the microcontroller 200 (FIG. 2) determines whether the magnitude of the change in the acceleration of the berry impact recording device 100 exceeds a predefined threshold value. By setting a minimum threshold value, the berry impact recording device 100 is able to disregard the general jostling that occurs during mechanical harvesting and/or processing of berries, but still record data related to impact events that would bruise or otherwise damage berries during mechanical harvesting and/or processing. If the magnitude of the change in the acceleration of the berry impact recording device 100 exceeds the predefined threshold, then executing proceeds to box 509. Otherwise execution ends.

Referring next to box 509, the microcontroller 200 writes the change in acceleration detected by the sensor in box 503 to memory 203 (FIG. 2). The data may be compressed and/or written to the memory 203 using a 64-bit word or, for 32-bit architectures, as a pair of 32-bit words. For example, in some embodiments, the data may be written such that 2 bits are used to describe the type of impact experience by the sensor 109, the acceleration is described using 30 bits, with 10 bits each to store acceleration on the X-axis, Y-axis, and Z-axis, and the a 32-bit timestamp is used to identify when the sensor reading occurred. Table 1 below reflects the layout of the data written to memory 203, as may be implemented in various embodiments of the present disclosure.

TABLE 1
Structure of Impact Data Written to Memory.

| | Impact | | | | |
|---|---|---|---|---|---|
| Field | type | Acceleration | | | Tick |
| Name | Impact | X axis | Y axis | Z axis | Tick |
| | type | | | | |
| Bits | 2 | 10 | 10 | 10 | 32 |
| Description | 1,2: impact | Acceleration | Acceleration | Acceleration | 1 |
| | data | of X axis | of X axis | of X axis | tick |

The flowcharts of FIGS. 3, 4, and 5 show the functionality and operation of an implementation of portions of the berry impact recording device 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the microcontroller 200. The machine code may be converted from the source code, etc. If embodied in hardware, each block may represent a circuit or a number of interconnected circuits to implement the specified logical function(s).

Although the flowcharts of FIGS. 3, 4, and 5 show a specific order of execution, it is understood that the order of execution may differ from that which is depicted. For example, the order of execution of two or more blocks may be scrambled relative to the order shown. Also, two or more blocks shown in succession in FIGS. 3, 4, and 5 may be executed concurrently or with partial concurrence. Further, in some embodiments, one or more of the blocks shown in FIGS. 3, 4, and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a microcontroller 200, a processor in a computer, or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A berry impact recording device, comprising:
a shell;
a sensor located within the shell, wherein the sensor is configured to at least:
detect an acceleration of the berry impact recording device;
report the acceleration of the berry impact recording device to an integrated circuit within the shell;
detect a pressure applied to the berry impact recording device; and
report the pressure applied to the berry impact recording device to the integrated circuit; and
wherein the integrated circuit is configured to at least:
record the acceleration of the berry impact recording device and a timestamp corresponding to when the acceleration was reported or detected; and
record the pressure applied to the berry impact recording device and a timestamp corresponding to when the pressure was reported or detected.

2. The berry impact recording device of claim 1, wherein the shell comprises a shape of a berry and at least one dimension of the berry.

3. The berry impact recording device of claim 1, wherein the integrated circuit is further configured to at least:
determine that a magnitude of the acceleration exceeds a predefined threshold; and
record the acceleration and the timestamp in response to a determination that the magnitude of the acceleration exceeds the predefined threshold.

4. The berry impact recording device of claim 1, wherein the acceleration comprises an acceleration vector corresponding to an X-axis.

5. The berry impact recording device of claim 1, wherein the acceleration comprises an acceleration vector corresponding to a Y-axis.

6. The berry impact recording device of claim 1, wherein the acceleration comprises an acceleration vector corresponding to a Z-axis.

7. The berry impact recording device of claim 1, further comprising a serial port interface communicatively coupled with the integrated circuit and externally accessible through the shell.

8. The berry impact recording device of claim 1, further comprising a universal serial bus (USB) interface communicatively coupled with the integrated circuit and externally accessible through the shell.

9. An apparatus, comprising:
a shell;
a sensor located within the shell, wherein the sensor is configured to at least detect an acceleration of the apparatus and report the acceleration of the apparatus; and
at least one integrated circuit within the shell, wherein the integrated circuit is configured to at least:
record the acceleration of the apparatus reported by the sensor and a timestamp corresponding to the reported acceleration of the apparatus.

10. The apparatus of claim 9, wherein the sensor comprises a first sensor and the apparatus further comprises:
a second sensor located within the shell, wherein the second sensor is configured to at least detect a pressure applied to the apparatus and report the pressure applied to the apparatus; and
the at least one integrated circuit is further configured to at least record the pressure applied to the apparatus reported by the sensor and a timestamp corresponding to the reported pressure.

11. The apparatus of claim 9, wherein the shell comprises a shape of a berry and at least one dimension of the berry.

12. The apparatus of claim 9, wherein the at least one integrated circuit is further configured to at least:
determine that a magnitude of the acceleration exceeds a predefined threshold; and
record the acceleration and the timestamp in response to a determination that the magnitude of the acceleration exceeds the predefined threshold.

13. The apparatus of claim 9, wherein the acceleration comprises an acceleration vector corresponding to an X-axis.

14. The apparatus of claim 9, wherein the acceleration comprises an acceleration vector corresponding to a Y-axis.

15. The apparatus of claim 9, wherein the acceleration comprises an acceleration vector corresponding to a Z-axis.

16. A system, comprising:
a spherical shell comprising:
a diameter not greater than a quarter of an inch; and
a hole shaped to match an external communications interface;
a circuit board within the shell and comprising:
the external communications interface; and
a microcontroller; and
a sensor within the shell and communicatively coupled to the microcontroller.

17. The system of claim 16, wherein the external communications interface comprises a serial port interface complying with the RS-232 standard.

18. The system of claim 16, wherein the external communications interface comprises a universal serial bus (USB) interface complying with a version of the USB protocol.

19. The system of claim 16, wherein the sensor comprises an accelerometer.

20. The system of claim 16, wherein the sensor comprises a pressure sensor.
